(19) United States
(12) Patent Application Publication
(10) Pub. No.: US 2015/0350587 A1
(43) Pub. Date: Dec. 3, 2015

(54) METHOD OF CONTROLLING DISPLAY DEVICE AND REMOTE CONTROLLER THEREOF

(71) Applicant: SAMSUNG ELECTRONICS CO., LTD., Suwon-si (KR)

(72) Inventors: Jae-yeop KIM, Seoul (KR); Kwan-min LEE, Seoul (KR); Jean-Christophe NAOUR, Anyang-si (KR); Joon-ho PHANG, Seoul (KR); Ha-yeon YOO, Seongnam-si (KR)

(73) Assignee: SAMSUNG ELECTRONICS CO., LTD., Suwon-si (KR)

(21) Appl. No.: 14/725,355

(22) Filed: May 29, 2015

(30) Foreign Application Priority Data
May 29, 2014 (KR) 10-2014-0065338

(51) Int. Cl. H04N 5/44

(52) U.S. Cl. CPC H04N 5/4403; H04N 2005/4408; H04N 2005/443

(57) ABSTRACT

According to one or more exemplary embodiments, a method of a remote controller for controlling a display device includes capturing an image of an object; detecting information about at least one of the shape, location, distance, and movement of the object based on the captured image; and transmitting the detected information to the display device.

### CROSS-REFERENCE TO RELATED APPLICATION(S)

This application claims priority from Korean Patent Application No. 10-2014-0065338, filed on May 29, 2014, in the Korean Intellectual Property Office, the disclosure of which is incorporated herein by reference in its entirety.

### BACKGROUND

1. Field

Apparatuses and methods consistent with exemplary embodiments relate to a remote controller and a method of controlling a displaying device using a remote controller.

2. Description of the Related Art

As a result of the rapid development of multimedia technologies and network technologies, the performance of display devices such as televisions (TVs) has been rapidly enhanced. As a result, a display device is capable of providing a large quantity of information, at the same time, and also providing a variety of functions such as games and the like.

Therefore, in an effort to more easily control the increased amount of information that is capable of being displayed on a display device and to enable a user to interact with a variety of functions such as games, the display device needs to be more intuitive and capable of various interactions with a user. However, current remote controllers for controlling TVs typically only transmit inputs that correspond to a keypad thereof, and thus, the amount and type of inputs of the user that can be transmitted to the display device through the remote controller are limited. Accordingly, the interaction of a user with the display device is also limited by the related remote controller.

### SUMMARY

Exemplary embodiments overcome the above disadvantages and other disadvantages not described above. Also, an exemplary embodiment is not required to overcome the disadvantages described above, and an exemplary embodiment may not overcome any of the problems described above.

One or more exemplary embodiments are related to a remote controller and a method of controlling a screen of a display using a remote controller.

Additional aspects will be set forth in part in the description which follows, and, in part, may be apparent from the description, or may be learned by practice of one or more of the exemplary embodiments.

According to an aspect of an exemplary embodiment, there is provided a method for a remote controller to control a display device, the method including capturing an image of an object; detecting information about at least one of a shape, location, distance, and movement of the object based on the captured image; and transmitting the detected information to the display device.

The capturing an image of an object may include capturing an image of the object from a motion sensor included in the remote controller.

The method may further include: detecting at least one of an angle and a direction of the remote controller; comparing at least one of the detected angle and direction with a reference range; and selectively activating the motion sensor included in the remote controller based on the comparison.

The activating the motion sensor may include activating one of the motion sensor and a touch sensor, which are included in the remote controller, based on the comparison.

The detecting information about at least one of the shape, location, distance and movement of the object may include: detecting a boundary of the object included in the captured image that matches a template stored in advance; and detecting information about at least one of the shape, location, distance, and movement of the object based on the detected boundary.

The template stored in advance may be a template of a shape of a finger.

The method may further include: receiving a user input of a user touching a partial area of a ridge bar provided in the remote controller; and transmitting location information about the touched partial area to the display device.

According to an aspect of another exemplary embodiment, there is provided a remote controller including: a communicator configured to transmit and receive data to and from a display device; an image obtainer configured to capture an image of an object; and a controller configured to, based on the captured image, detect information about at least one of the shape, location, distance, and movement of the object, and transmit the detected information to the display device through the communicator.

The image obtainer may include a motion sensor.

The control unit may be configured to detect at least one of an angle and a direction of the remote controller; compare at least one of the detected angle and the direction with a reference range; and selectively activate the motion sensor provided in the remote controller based on the comparison.

The controller may be further configured to activate one of the motion sensor and a touch sensor, which are included in the remote controller, based on the comparison.

The controller may be further configured to detect a boundary of the object included in the captured image that matches a template stored in advance, and detect information about at least one of the shape, location, distance, and movement of the object based on the detected boundary.

The template stored in advance may include a template of a shape of a finger.

The remote controller may further include: a ridge bar; and a user interface configured to receive a user input of a user touching a partial area of the ridge bar, and wherein the controller may be further configured to transmit, to the display device, information about a location of the partial area that the user touched.

According to an aspect of an exemplary embodiment, a computer-readable recording medium may include a computer program for executing the methods described herein.

According to an aspect of another exemplary embodiment, there is provided a control apparatus including: a communicator configured to transmit and receive data to and from a display apparatus; a ridge bar configured to receive a user input; and a controller configured to determine a location of the user input, and control the display apparatus according to the location of the user input.

The controller may be further configured to determine a ratio corresponding to a comparison between the location of the user input and an entire length of the ridge bar; and according to the determined ratio, determine a replay time point for a video that is being displayed on the display apparatus.

The display apparatus may further include a user interface.

The user interface may be further configured to display a plurality of thumbnail images corresponding to a plurality of time points in the video.

The user interface may be further configured to display the thumbnail image, from among the plurality of thumbnail images, that corresponds to the replay time point, with a distinguishing feature.

### BRIEF DESCRIPTION OF THE DRAWINGS

These and/or other aspects will become more apparent and more readily appreciated from the following description of the exemplary embodiments, taken in conjunction with the accompanying drawings, in which:

FIG. 1 is a diagram illustrating a remote controller according to an exemplary embodiment;

FIG. 2 is a flowchart illustrating a method in which a remote controller selectively activates a sensor that is included in the remote controller, according to an exemplary embodiment;

FIGS. 3A and 3B are diagrams illustrating a remote controller selectively activating a sensor that is included in the remote controller, according to an exemplary embodiment;

FIG. 4 is a flowchart illustrating a method of a remote controller recognizing an object and transmitting information about the recognized object to a display device, according to an exemplary embodiment;

FIG. 5 is a flowchart illustrating a method of a display device receiving information about a motion of a user that is recognized by a remote controller and controlling a screen of the display device, according to an exemplary embodiment;

FIG. 6 is a diagram illustrating a remote controller controlling a display device using a motion sensor, according to an exemplary embodiment;

FIG. 7 is a diagram illustrating a remote controller controlling a display device using a motion sensor, according to an another exemplary embodiment;

FIG. 8 is a flowchart illustrating a method in which a display device receives a user input through a ridge bar of a remote controller and controls a screen of the display device, according to an exemplary embodiment;

FIG. 9 is a diagram illustrating a display device receiving a user input through a ridge bar of a remote controller and controlling a screen according to an exemplary embodiment;

FIG. 10 is a block diagram illustrating a remote controller according to an exemplary embodiment; and

FIG. 11 is a block diagram illustrating a display device according to an exemplary embodiment.

### DETAILED DESCRIPTION

Some of the terms used in the exemplary embodiments are briefly explained and the exemplary embodiments are further explained in detail.

The terms used in describing one or more exemplary embodiments are selected from terms that are commonly used while considering functions in the disclosure, but terms may change according to the intention of those skilled in the art, case law, the appearance of new technologies, and the like. Also, there may be terms selected by applicant's own decision and in such cases, the meanings will be explained in a corresponding part of the detailed description. Accordingly, the terms used in describing one or more exemplary embodiments should be defined, not as simple names, but based on the meanings of the terms and the contents of the exemplary embodiments of the disclosure as a whole.

It should be understood that the terms “comprises” and/or “comprising”, when used in this specification, do not preclude the presence or addition of one or more other features unless otherwise expressly described. Also, terms such as “unit” and “module” are used to indicate a unit for processing at least one function or operation and may be implemented by hardware, software, or a combination of hardware and software.

Reference will now be made to the exemplary embodiments, examples of which are illustrated in the accompanying drawings, such that one of ordinary skill in the art may implement the embodiments. However, the it should be appreciated that the exemplary embodiments may have different forms and should not be construed as being limited to the descriptions set forth herein. Also, irrelevant parts in drawings or descriptions of functions and constructions known in the art may be omitted. Furthermore, like reference numerals refer to like elements throughout.

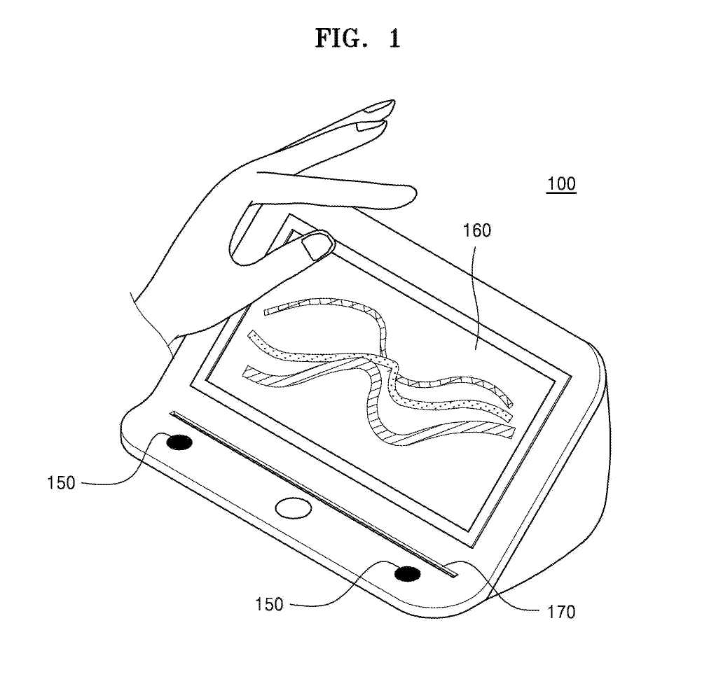

FIG. 1 is a diagram illustrating a remote controller 100 according to an exemplary embodiment.

Referring to FIG. 1, the remote controller 100 may recognize a shape, location, distance, and/or movement of an object using a motion sensor 150. For example, if a user moves their finger into a sensing space of the motion sensor 150, the remote controller 100 may recognize the shape of the finger, location of the finger, and a distance of the finger of the user. Here, the distance may be the distance from the finger to the remote controller 100. Also, for example, when the user moves the finger while in the sensing space of the motion sensor 150, the remote controller 100 may track a movement of the finger. The remote controller 100 may transmit information about the shape, location, distance, and/or movement of the recognized object to a display apparatus 200.

The remote controller 100 may receive a user input through a touch of the user on a partial area of a touch screen 160. When the user input is received, the remote controller 100 may calculate the location of the touched area with respect to the entire touch screen 160.

The remote controller 100 may display a user interface on the touch screen 160. Also, the remote controller 100 may include a separate touch pad. For example, the remote controller 100 may receive a user input through the touch pad or the touch screen 160 and may transmit the received user input to the display device 200.

According to one or more exemplary embodiments, the remote controller 100 may receive a user input through a ridge bar 170. In this example, the ridge bar 170 is disposed towards the bottom of the face of the remote controller, but the exemplary embodiments are not limited thereto. The ridge bar 170 may include a touch pad that has a thin and long bar shape. The ridge bar 170 may have a protruding or recessed shape. As an example, the remote controller 100 may receive a user input through a touch at an area of the ridge bar 170 such as a predetermined area. As the user input is received, the remote controller 100 may calculate the location of the touched predetermined area with respect to the entire length of the ridge bar 170. The remote controller 100 may transmit the user input received through the ridge bar 170 to the display device 200.

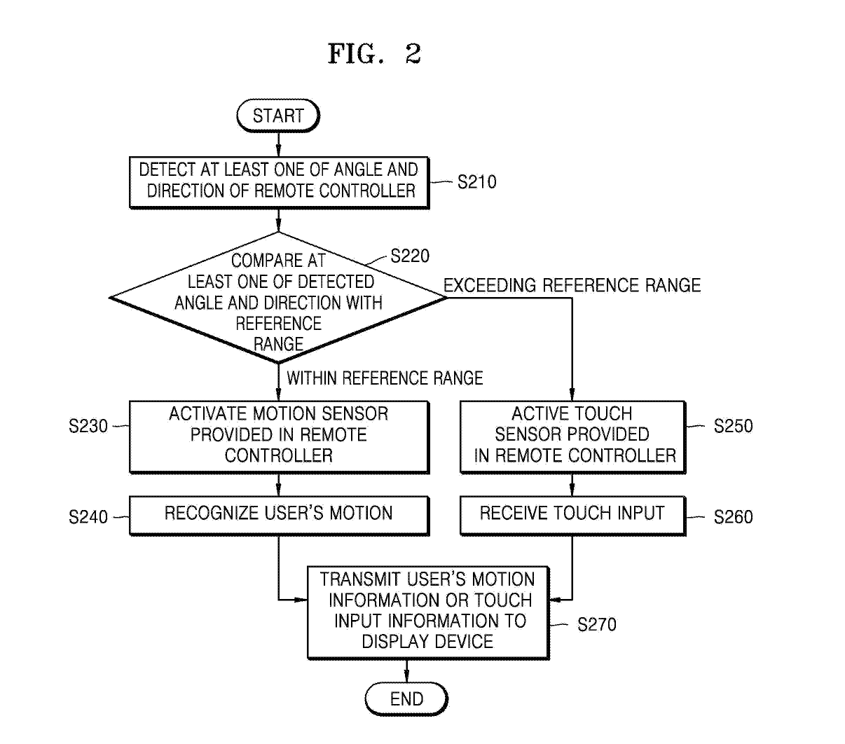

FIG. 2 is a flowchart illustrating a method in which a remote controller 100 selectively activates a sensor that is included in the remote controller 100, according to an exemplary embodiment.

Referring to FIG. 2, in operation S210, the remote controller 100 detects at least one of an angle and a direction of the remote controller 100. For example, the remote controller 100 may include at least one of a gyro sensor, a terrestrial magnetic sensor, an acceleration sensor, and the like, which may be used to detect at least one of the angle and direction of the remote controller 100. For example, the angle and direction of the remote controller 100 may be determined with respect to gravity.

In operation S220, the remote controller 100 compares at least one of a detected angle and direction with a reference range. For example, a reference range for at least one of the angle and the direction may be set or may be predetermined and stored in the remote controller 100. By detecting at least one of the angle and direction, the remote controller 100 may determine whether or not at least one of the detected angle and direction is within the reference range.

In this example, if the remote controller 100 determines in operation S220 that at least one of the detected angle and the direction is within a reference range, the remote controller 100 activates a motion sensor 150 that is included in the remote controller 100 in operation S230. For example, when at least one of the detected angle and direction is within the reference range, the remote controller 100 may activate the motion sensor 150 and deactivate a touch sensor at the same time, or may maintain the activated state or deactivated state of the touch sensor. Also, the remote controller 100 may activate the motion sensor 150 when both the detected angle and the detected direction are each within a reference range.

When the motion sensor 150 is activated, the remote controller 100 may provide information indicating that the motion sensor 150 is activated. For example, the remote controller 100 may display information indicating that the motion sensor 150 is activated on a screen of the remote controller 100. When the touch sensor is deactivated, the remote controller 100 may display information indicating that the touch sensor is deactivated on the screen of the remote controller 100.

In operation S240, the remote controller 100 recognizes a motion of the user using the activated motion sensor 150. For example, when the motion sensor 150 is activated, the motion sensor 150 may capture a photo of an object located in a sensing space of the motion sensor 150 using a camera that is included in the remote controller 100. The remote controller 100 may detect information about at least one of the shape, location, distance, and movement of an object from an image obtained by photographing the object.

On the contrary, when it is determined that at least one of the detected angle and direction exceeds the reference range in operation S220, the remote controller 100 activates the touch sensor included in the remote controller 100 in operation S250. For example, when at least one of the detected angle and direction exceeds the reference range, the remote controller 100 may activate the touch sensor and deactivate the motion sensor 150 at the same time.

When the touch sensor is activated, the remote controller 100 may provide information indicating that the touch sensor is activated. For example, the remote controller 100 may display information indicating that the touch sensor is activated on a screen of the remote controller 100. Also, the remote controller 100 may display information indicating that the motion sensor 150 is deactivated on a screen of the remote controller 100.

In operation S260, the remote controller 100 receives a touch input of the user using the activated touch sensor. For example, when the touch sensor is activated, the remote controller 100 may detect a location of an area touched by the user with respect to the entire area of the touch sensor.

In operation S270, the remote controller 100 transmits to the display device 200 information about at least one of a shape, location, distance, and movement of the object detected using the activated touch sensor or information about the touched location.

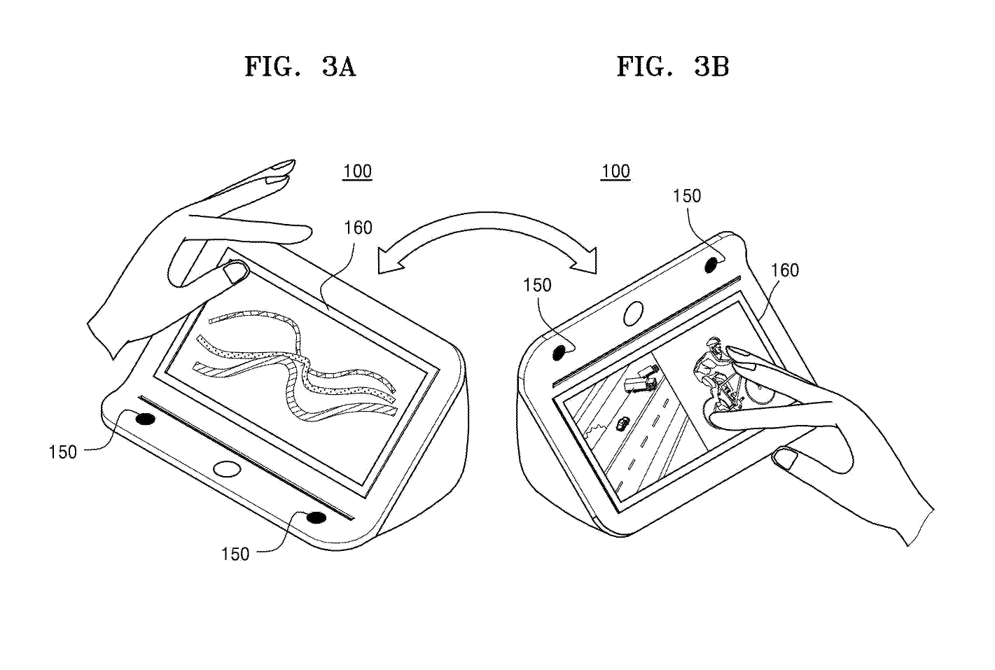

FIGS. 3A and 3B are diagrams illustrating a remote controller 100 selectively activating a sensor included in the remote controller 100, according to an exemplary embodiment.

Referring to FIGS. 3A and 3B, the remote controller 100 may include a triangular prism shape. In this example, a user input device such as a touch screen 160, a ridge bar 170, and a motion sensor 150 may be included on a side of the triangular prism. One side selected by the user from among the other two sides of the triangular prism that do not include the user input features may be put on a flat surface in order to support the remote controller 100.

Referring to FIG. 3A, the remote controller 100 may be put on the flat surface such that the motion sensor 150 is placed on the flat surface. In this example, because the motion sensor 150 is placed on the flat surface, the remote controller 100 may detect the angle and direction of the remote controller 100. For example, if the detected angle and direction are within a reference range, the remote controller 100 may activate the motion sensor 150 and deactivate the touch sensor. A state in which the motion sensor 150 of the remote controller 100 is activated and the touch sensor is deactivated, may be referred to as a hand motion control mode.

Referring to FIG. 3B, an angle and a direction of the remote controller 100 may be changed and the motion sensor 150 may not come into contact with the flat surface. In this example, because the surface supporting the remote controller 100 is changed in the triangular prism, the angle and direction of the remote controller 100 may also change. Accordingly, as the angle and direction of the remote controller 100 change, the remote controller 100 may detect the changed angle and direction.

If at least one of the changed angle and direction of the remote controller 100 exceed a reference range, the remote controller 100 may deactivate the motion sensor 150 and activate the touch sensor. A state in which the motion sensor 150 is deactivated and the touch sensor is activated may be referred to as a touch mode.

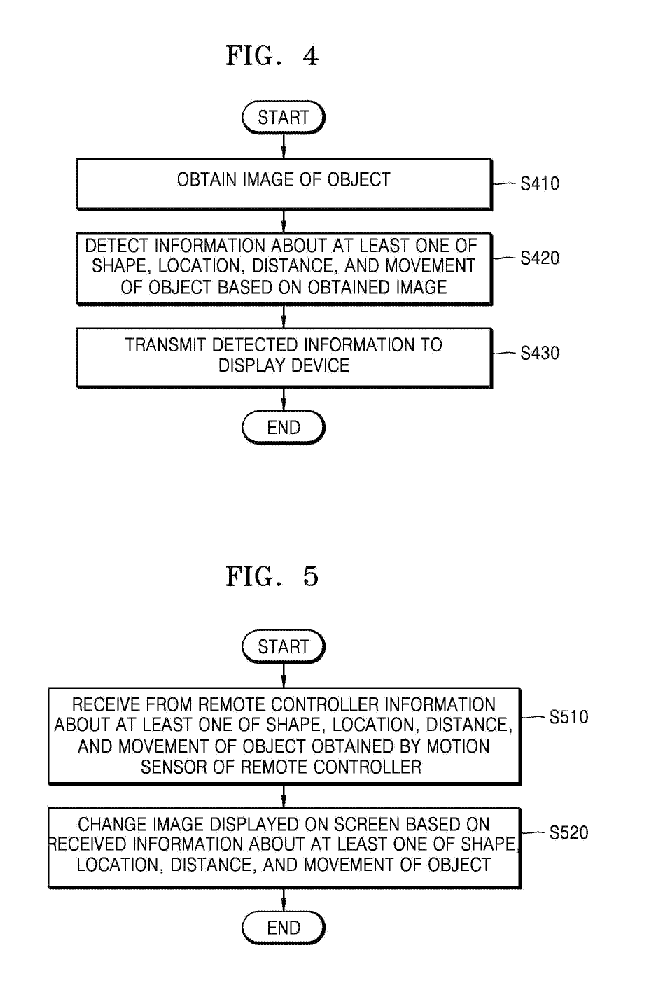

FIG. 4 is a flowchart illustrating a method of a remote controller 100 recognizing an object and transmitting information about the recognized object to a display device 200, according to an exemplary embodiment.

Referring to FIG. 4, in operation S410, the remote controller 100 obtains an image of the object. For example, the remote controller 100 may activate the motion sensor 150 based on at least one of the angle and direction of the remote controller 100. When the motion sensor 150 is activated, the motion sensor 150 may take a photo of an object that is located in a sensing space of the motion sensor 150. Here, the object may refer to a finger or a part of or an entire hand of the user. The remote controller 100 may obtain an image of an object photographed by the motion sensor 150. For example, in response to the user placing a finger in the sensing space of the motion sensor 150, the remote controller 100 may capture an image of the finger of the user.

The motion sensor 150 may be preset such that the sensing space of the motion sensor 150 is placed at a predetermined area from or with respect to the remote controller 100. For example, the location of the motion sensor 150 in the remote controller 100 may be set so that the sensing space of the motion sensor 150 is formed above the ground surface on which the remote controller 100 is placed. In this example, when the user moves a finger at a predetermined height above the remote controller 100, the remote controller 100 may recognize the movement of the finger of the user.

As an example, the motion sensor 150 may include a 3D camera sensor, an infrared light sensor, and the like, but is not limited to these examples. Also, the motion sensor 150 may include a light source unit which emits light toward an object and a sensing unit which senses light reflected from an object. As another example, the motion sensor 150 may include only a sensing unit which senses light reflected from an object. The light, which is emitted toward an object, may include lights with a variety of wavelengths such as infrared rays, ultraviolet rays, visible light, X-rays, and the like. The motion sensor 150 may be referred to as a motion gesture sensor (MGS), or an optical motion sensor in some examples.

In operation S420, the remote controller 100 detects information about at least one of the shape, location, distance, and movement of an object based on an image obtained in operation S410. The remote controller 100 may recognize at least one of a shape, location, distance, and movement of the object based on an image of the object that is obtained by the motion sensor 150.

For example, the motion sensor 150 may include an RGB camera, and the motion sensor 150 may receive visible light that is reflected from the object and generate a color image of the object. For example, the remote controller 100 may detect a boundary of the object from the generated color image. Using the detected boundary of the object, the remote controller 100 may detect the shape and location of the object.

For example, if the motion sensor 150 includes a light source unit which emits infrared rays and a sensing unit which receives infrared rays that are reflected from an object, the motion sensor 150 may generate an image of the object with varying brightness of pixels according to the intensity of the received infrared rays. In this example, the remote controller 100 may receive the image of the object from the sensing unit and may detect the distance to the object from the sensing unit based on a brightness of the pixels of the received image of the object.

As another example, the remote controller 100 may detect the boundary or frame of on object, track the detected boundary and frame over the course of time, and detect a movement of the object. For example, the potential shape or shapes of an object, which may be detected, may be stored in advance in the remote controller 100. For example, a potential object to be detected may be a finger of a human body. In this example, the shapes of a finger according to gestures may be stored as a template in the remote controller 100. In this example, the remote controller 100 may detect a boundary of a shape, which is similar to the template, in an image that is received from the motion sensor 150. Accordingly, the remote controller 100 may recognize the gesture of a finger made by the user.

The remote controller 100 may detect the boundary of the object matching a template stored in advance from an obtained image. Based on the detected boundary, the remote controller 100 may detect information about at least one of the shape, location, distance, and movement of the object.

In operation S430, the remote controller 100 transmits the detected information to the display device 200. For example, the remote controller 100 may transmit in real time to the display device 200, information about at least one of the shape, location, distance, and movement of the object.

The remote controller 100 may transmit all of the detected information about at least one of the shape, location, distance, and movement of the object to the display device 200 or may transmit only part of the detected information that is requested by the display device 200. For example, instead of information about the shape, location, distance, and movement of the entire finger of the user, information about only a location, distance, and movement of the end of a hand may be transmitted to the display device 200.

FIG. 5 is a flowchart illustrating a method of a display device 200 receiving information about a motion of a user recognized by a remote controller 100 and controlling a screen according to an exemplary embodiment.

Referring to FIG. 5, in operation S510, the display device 200 receives, from the remote controller 100, information about at least one of the shape, location, distance, and movement of an object detected by a motion sensor 150 of the remote controller 100.

As another example, the display device 200 may receive information about a user input obtained by a touch sensor of the remote controller 100 from the remote controller 100. When one of the motion sensor 150 and the touch sensor of the remote controller 100 are activated, the display device 200 may receive information indicating a type of an activated sensor from the remote controller 100. For example, the display device 200 may determine a type of user input that is received from the remote controller 100.

In operation S520, the display device 200 changes an image displayed on a screen based on the received information about at least one of the shape, location, distance, and movement of the object.

Various operations may be paired with various gestures of a user. For example, an operation that is to be executed by the display device 200 in response to a finger gesture of a user may be preset in the display device 200. Also, the operation to be executed in response to the finger gesture may be set differently according to a type of an application. For example, depending on the application, the execution operation may be an operation of turning over a page that is displayed on the screen or it may be an operation of selecting an image object.

Accordingly, based on the shape, location, distance, and/or movement of the object, the display device 200 may determine the gesture of the object and execute an operation corresponding to the determined gesture.

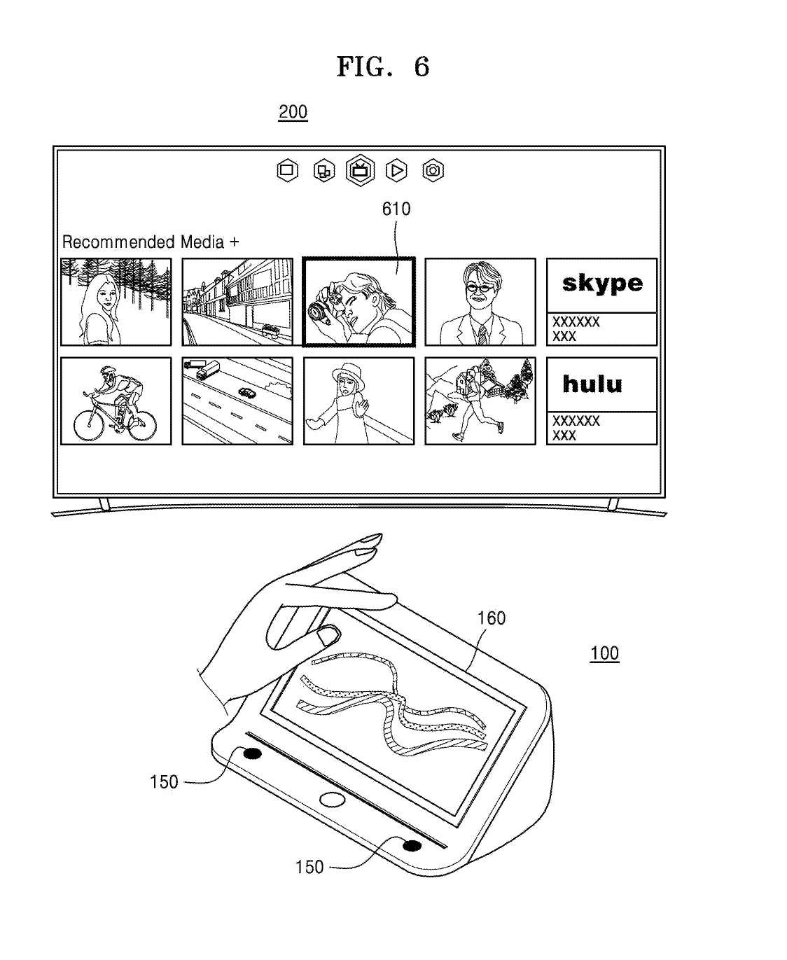

FIG. 6 is a diagram illustrating a remote controller 100 controlling a display device 200 using a motion sensor 150 according to an exemplary embodiment. Referring to FIG. 6, a user places his finger at a predetermined height above the remote controller 100. Here, the remote controller 100 may recognize a shape or an outline of the finger of the user. The remote controller 100 may also detect a location of the finger of the user in a sensing space of the remote controller 100 and a distance between the finger of the user and the remote controller 100. Accordingly, the remote controller 100 may transmit the detected shape, location and distance of the finger of the user to the display device 200.

For example, the display device 200 may perform an execution operation for selecting an image object corresponding to a shape of a hand making a first with the forefinger stretched out. In this example, when the shape of fingers making a first with the forefinger stretched out is received, the display device 200 may select an image object 610, which is displayed on the location of the screen corresponding to the location of the finger of the user in the sensing space, from among a plurality of image objects.

When the image object 610 is selected, the display device 200 may display the selected image object 610 such that the selected image object 610 may be distinguished from other image objects.

For example, as the user moves his entire hand while making a first with the forefinger stretched out, the display device 200 may select another image object based on the movement of the hand.

As another example, while making a first with the forefinger stretched out, an execution operation for clicking an image object may be performed in response to a gesture of moving the forefinger upwards or downwards. As the gesture of moving the forefinger upwards and downwards is received, the display device 200 may execute an operation of clicking the selected image object.

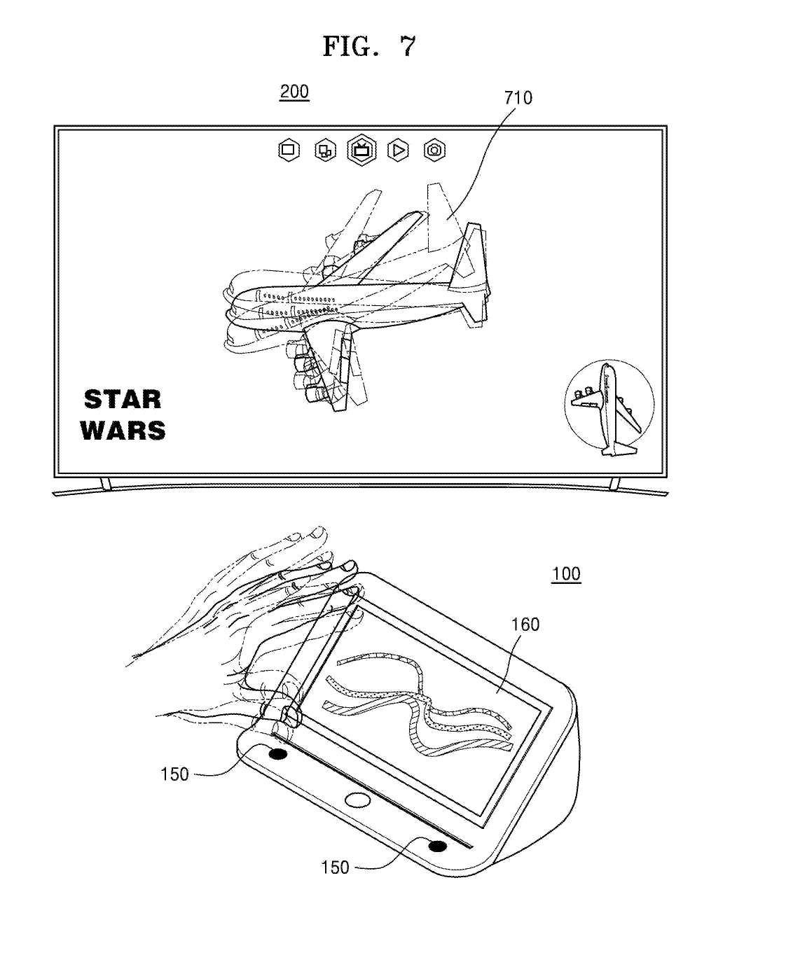

FIG. 7 is a diagram illustrating a remote controller 100 controlling a display device 200 using a motion sensor 150, according to an exemplary embodiment.

In the example of FIG. 7, a flying game, in which an airplane 710 moves according to user manipulation, may be executed in the display device 200. In this example, an execution operation for moving the airplane 710 in response to the movement of a hand with each of the fingers stretched may be set. In this example, a user may move his hand and a corresponding direction of the hand movement may be detected by the display apparatus 100.

In this example, when the movement of the hand is received, the display device 200 may move the airplane 710 on a screen to a location of the screen corresponding to the moving location of the hand in the sensing space. Also, as a gesture of tilting a hand of the user to the left or right is received, the display device 200 may execute an operation according to the tilt of the airplane 710 to the left or right.

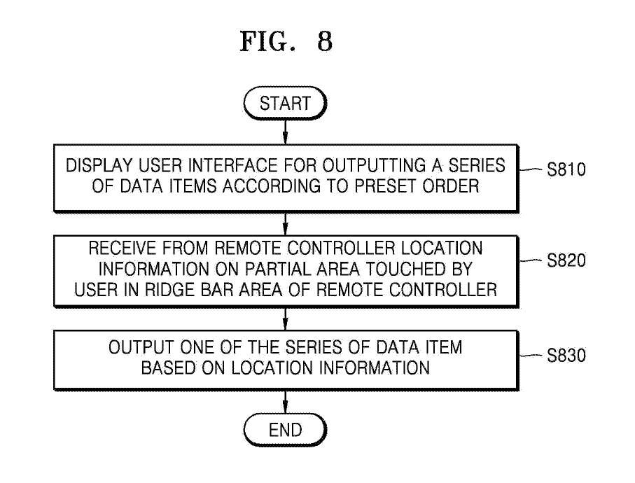

FIG. 8 is a flowchart illustrating a method in which a display device 200 receives a user input received by a ridge bar 170 of a remote controller 100 and controls a screen, according to an exemplary embodiment.

In operation S810, the display device 200 displays a user interface for outputting a series of data items according to a preset order. For example, the outputting of the order of the series of data items may be preset. For example, the series of data items may include moving picture contents, music contents, electronic books, and the like. Also, the user interface may include the order of the data items being output and the total number of data items. For example, the user interface may include a bar in the horizontal direction corresponding to the entire data.

In operation S820, the display device 200 receives, from the remote controller 100, location information on a partial area which is touched by the user, in the area of the ridge bar 170 of the remote controller 100.

For example, the location information on the touched partial area of the screen of the display device 200 may include the length information between the touched partial area from a reference point and the entire length information of the ridge bar 170. For example, the location information may include a length of an area of the screen that is touched by a user. Also, the location information on the touched partial area may include information about a ratio of the length from the touched partial area from the reference point in comparison to the entire length of the ridge bar 170.

In operation S830, the display device 200 outputs one of the series of data items based on the location information. The display device 200 may calculate the ratio of the length from the touched partial area of the reference point with respect to the entire length of the ridge bar 170.

According to the calculated ratio, the display device 200 may output one or more of the series of data items. For example, when the series of data items include moving picture contents, the display device 200 may determine a replay time corresponding to the touched location. For example, the display device 200 may replay the moving picture from the determined replay time point.

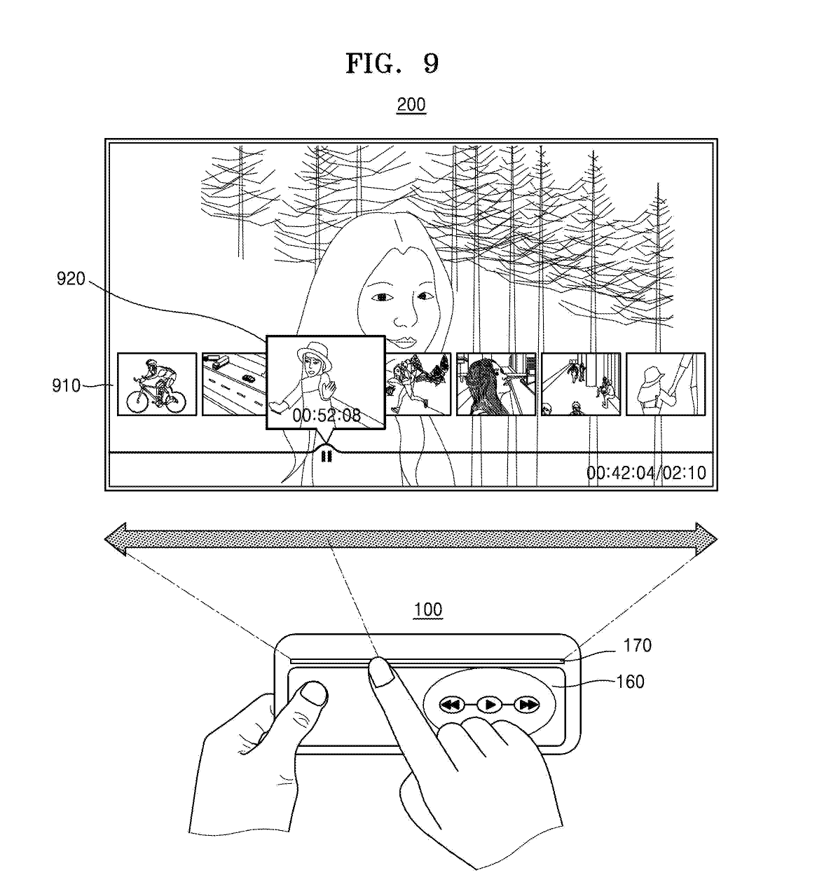

FIG. 9 is a diagram illustrating a display device 200 receiving a user input that is input through a ridge bar 170 of a remote controller 100 and controlling a screen of the display device 200, according to an exemplary embodiment.

Referring to FIG. 9, the display device 200 may reproduce moving picture contents on a screen of the display device 200. For example, the remote controller 100 may receive a user input of a user touching the ridge bar 170 in an example in which the remote controller 100 is operating as an absolute pointing device. For example, when a partial area of the ridge bar 170 is touched, the remote controller 100 may transmit a location of the touched partial area of the ridge bar 170 to the display device 200.

In some examples, the display device 200 may receive from the remote controller 100 the location of the touched partial area of the ridge bar 170. For example, when the location of the touched partial area of the ridge bar 170 is received, the display device 200 may determine a replay point in time such that the time ratio of the selected replay time point with respect to the entire replay time is the same as the ratio of the length of the touched partial area from the start point of the ridge bar 170 with respect to the entire length of the ridge bar 170. For example, if a point is touched at which the length from the start point of the ridge bar is one third of the entire length of the ridge bar 170, the display device 200 may determine a replay time point, which is one third of the entire replay time, as the replay time point selected by the user.

As an example, the display device 200 may display a user interface that enables a user to select a replay time point. For example, the user interface may include time information of a replay time point that is selected by a user and a thumbnail image 910 of a frame that is to be replayed in a time range neighboring the replay time point. Also, the user interface may display a thumbnail image 920 of the replay time point that is selected by the user such that the thumbnail image 920 is distinguished from the other thumbnail images 910 of other frames. For example, the user interface may display a thumbnail image 920 of a replay point in time that is selected by the user in a size that is bigger than a size of the other thumbnail images 910.

Also, the user may scroll the ridge bar 170 to the left or to the right while a finger is touching the ridge bar 170 (Relative Touch). In this example, the display device 200 may receive a change in location based on the touched location from the remote controller 100. For example, based on the changed touched location, the display device 200 may move forwards or backwards from the replay point in time that is selected by the user. Based on the moved replay point in time, the display device 200 may display time information of the moved replay point in time and the frames in a time range that are next to or that are neighboring the moved replay time point in thumbnails.

Also, the remote controller 100 may display a user interface to select a replay point in time on the touch screen 160 of the remote controller 100. For example, the remote controller 100 may display a user interface for operations, such as replay, pause, forward, and backward, on the touch screen 160.

A user interface for displaying data items in a time order may be a graphical user interface (GUI) in a horizontal direction. Accordingly, by attaching a thin and long ridge bar 170 in a horizontal direction similar to a GUI in a horizontal direction, the user may intuitively select a data item by using the ridge bar 170 without having to learn new processes that may be confusing.

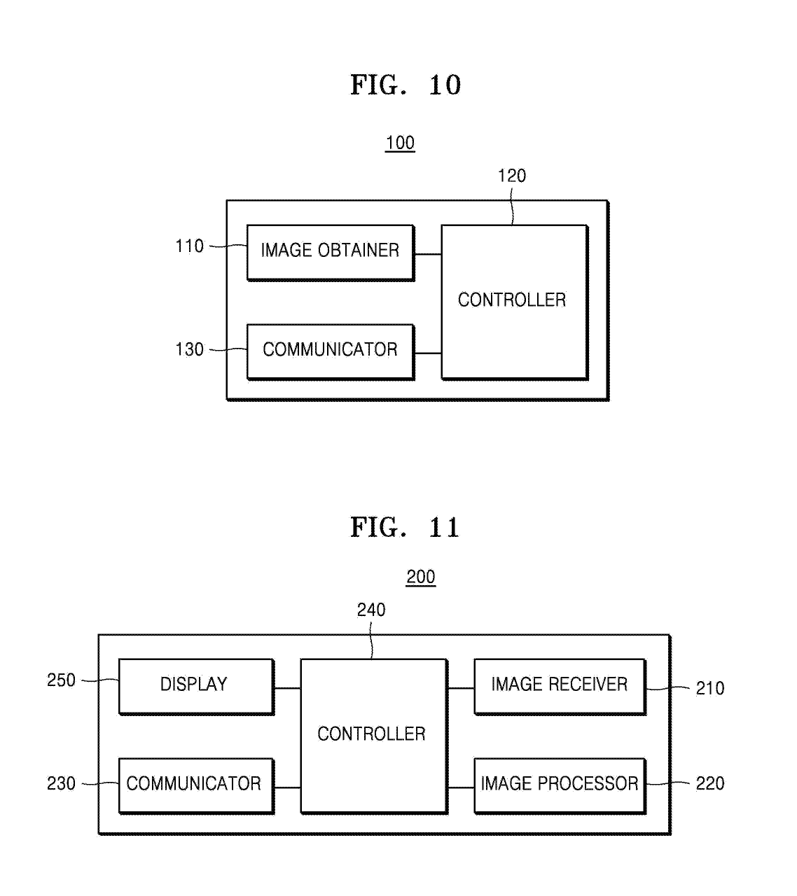

FIG. 10 is a block diagram of a remote controller 100 according to an exemplary embodiment.

Referring to FIG. 10, the remote controller 100 may include an image obtainer 110, a control unit 120 (e.g., controller), and a communicator 130.

The image obtainer 110 may obtain an image of an object close to the remote controller 100. The image obtainer 110 may include a motion sensor 150. The image obtainer 110 may obtain an image of an object, which is captured by the motion sensor 150.

The communicator 130 may transmit or receive data to or from the display device 200 through short-range wireless communication.

Also, the communicator 130 may include a short-range wireless communication unit which includes a Bluetooth communication unit, a Bluetooth low energy (BLE) communication unit, a near field communication unit, a wireless local area network (WLAN, WiFi) communication unit, a ZigBee communication unit, an infrared Data Association (IrDA) communication unit, a WiFi Direct (WFD) communication unit, an ultra wideband (UWB) communication unit, and an Ant+ communication unit, but is not limited by these.

Also, the communicator 130 may transmit or receive a wireless signal to or from at least one of a base station on a mobile communication network, an external terminal, and a server. In this example, the wireless signal may include at least one of a voice call signal, a video communication call signal, and a variety of data forms according to text and/or multimedia message transmission and reception.

The control unit 120 may control the general operations of the remote controller 100. For example, the control unit 120 may execute programs stored in a storage unit, and thereby control the image obtainer 110, the control unit 120, and the communicator 130.

Also, the control unit 120 may activate the motion sensor 150 based on at least one of the angle and direction of the remote controller 100.

For example, the control unit 120 may detect at least one of the angle and direction of the remote controller 100. Also, the control unit 120 may compare at least one of the detected angle and direction with a reference range. Based on whether or not at least one of the detected angle and direction is within the reference range, the control unit 120 may activate the motion sensor 150.

Also, the control unit 120 may detect information about at least one of the shape, location, distance, and movement of an object, based on an image obtained by the image obtainer 110.

For example, the control unit 120 may detect the boundary of an object from a color image. By using the detected boundary of the object, the control unit 120 may detect the shape and location of the object. Also, based on the brightness of pixels of the image of the object, the control unit 120 may detect the distance of the object from a sensing unit. By detecting a boundary with a shape that is similar to a template, the control unit 120 may recognize a a finger gesture made by a user.

Also, through the communicator 130, the control unit 120 may transmit detected information to the display device 200.

Also, the remote controller 100 may include a storage unit. The storage unit may store in advance a shape of an object to be detected. For example, if the object desired to be detected is a finger of a human body, the shape of a finger of a human body according to a gesture may be stored as a template in the storage unit.

Also, the remote controller 100 may further include a display. By being controlled by the control unit 120, the display unit may display information being processed by the remote controller 100.

When the display and a touchpad have a layer structure to form a touch screen, the display may be used as an input device as well as an output device.

The display may include at least one of a liquid crystal display, a thin film transistor-liquid crystal display, an organic light-emitting diode display, a flexible display, a 3D display, and an electrophoretic display.

Also, the remote controller 100 may include a user input unit (e.g., user interface). The user input unit may receive a user input for controlling the remote controller 100. The user input unit may include at least one of a keypad, a dome switch, a touchpad (a contact-type capacitance method, a pressure-type resistance film method, an infrared sensing method, a surface ultrasound transmission method, an integral tension measuring method, a piezo effect method, and the like), a jog wheel, and a jog switch, but is not limited to these.

FIG. 11 is a block diagram of a display device 200 according to an exemplary embodiment.

Referring to FIG. 11, the display device 200 may include an image receiver 210, an image processor 220, a communicator 230, a control unit 240 (e.g., controller), and a display unit 250 (e.g., display).

The image receiver 210 may receive broadcasting data from an external network. For example, the image receiver 210 may receive at least one of a ground wave broadcasting signal, a cable broadcasting signal, an IPTV broadcasting signal, and a satellite broadcasting signal. Accordingly, the image receiver 210 may include at least one of a cable TV receiver, an IPTV receiver, and a satellite broadcasting receiver.

Also, the image receiver 210 may receive an image signal from an external device. For example, the image receiver 210 may receive at least one of an image signal from a PC, an audiovisual (AV) device, a smartphone, and a smart pad.

The image processor 220 may perform demodulation of at least one of a ground wave broadcasting signal, a cable broadcasting signal, an IPTV broadcasting signal, and a satellite broadcasting signal. The data after the demodulation may include at least one of compressed images, voice, and additional information. The image processor 220 may generate video raw data by performing decompression of the compressed images complying with MPEGx/H.264 standards. Also, the image processor 220 may generate audio raw data by performing decompression of the compressed voice complying with MPEGx/AC3/AAC standards. The image processor 220 may transmit the decompressed video data to the display unit 250.

The communicator 230 may transmit data or receive data to or from the remote controller 100 through short-range wireless communication.

The communicator 230 may perform data communication with an external server through a communication network such as a data communication channel for performing communication of data separate from the broadcasting contents received by the image receiver 210.

The communicator 230 may include at least one of a Bluetooth communication unit, a BLE communication unit, a near field communication unit, a wireless local area network (WLAN, WiFi) communication unit, a ZigBee communication unit, an IrDA communication unit, a WFD communication unit, a UWB communication unit, and an Ant+ communication unit, but is not limited to these.

Also, the communicator 230 may transmit or receive a wireless signal to or from at least one of a base station on a mobile communication network, an external terminal, and a server. Here, the wireless signal may include a voice call signal, a video communication call signal, or a variety of data forms according to text and/or multimedia message transmission and reception.

The controller 240 may control the display unit 250 to display information being processed by the display device 200.

Also, the display unit 250 may display video data decompressed by the image processor 220. For example, the display unit 250 may display images of at least one of a ground wave broadcast, a cable broadcast, an IPTV broadcast, and a satellite broadcast. Also, the display unit 250 may display an executed image of an application being executed by the controller unit 240.

When the display unit 250 and a touchpad have a layer structure to form a touch screen, the display unit 250 may be used as an input device as well as an output device. The display unit 250 may include at least one of a liquid crystal display, a thin film transistor-liquid crystal display, an organic light-emitting diode display, a flexible display, a 3D display, and an electrophoretic display. Furthermore, according to an exemplary embodiment, the display device 200 may include two or more display units 250.

Also, the display device 200 may include a user input unit. The user input unit may receive a user input for controlling the display device 200. The user input unit may include at least one of a keypad, a dome switch, a touchpad (a contact-type capacitance method, a pressure-type resistance film method, an infrared sensing method, a surface ultrasound transmission method, an integral tension measuring method, a piezo effect method, and the like), a jog wheel, and a jog switch, but is not limited to these.

Also, the user input unit may include a remote controller 100 that is separate from the display device 200.

The control unit 240 may control the overall operations of the display device 200. For example, the control unit 240 may execute programs stored in a storage unit, and thereby control the image receiver 210, the image processor 220, the communicator 230, the display unit 250, and the user input unit.

Through the communicator 230, the control unit may receive from the remote controller 100 information about at least one of the shape, location, distance, and movement of an object detected by the motion sensor 150 of the remote controller 100.

The control unit 240 may receive from the remote controller 100 information about a user input obtained by a touch sensor.

Also, as one of the motion sensor 150 and the touch sensor of the remote controller 100 is activated, the control unit 240 may receive from the remote controller 100 information indicating the type of the activated sensor. Accordingly, the control unit 240 may determine the type of the user input received from the remote controller 100.

Also, based on the received information about at least one of the shape, location, distance, and movement of the object, the control unit 240 may change an image displayed on the screen of the display unit 250. For example, based on the shape, location, distance, and movement of the object, the control unit 240 may determine the gesture of the object and execute an operation corresponding to the determined gesture.

The control unit 240 may display on the screen of the display unit 250 a user interface for outputting a series of data items in a preset order.

Also, from the remote controller 100, the control unit 240 may receive through the communicator 170 location information on a predetermined area touched by the user in an area of the ridge bar 170 of the remote controller 100.

Also, based on the location information, the control unit 240 may output one of the series of data items.

One or more exemplary embodiments may be implemented in the form of a recording medium including commands that may be executed by a computer such as a program module which is executed by a computer. The computer-readable medium may be a random available medium which may be accessed by a computer, and may include volatile and non-volatile media, and detachable and non-detachable media. Also, the computer-readable recording medium may include all of computer storage media and communication media. The computer storage media may include all of volatile and non-volatile media, and detachable and non-detachable media that are implemented by a method or technology for storing information, such as readable commands, data structures, program modules, or other data. The communication media may include computer-readable commands, data structures, program modules, or other data of modulated data signals or other transmission mechanism, and also includes arbitrary information transmission media.

While one or more exemplary embodiments have been described with reference to the figures, it should be understood by those of ordinary skill in the art that various changes in form and details may be made therein without departing from the spirit and scope as defined by the following claims. It should be understood that the exemplary embodiments described herein should be considered in a descriptive sense only and not for purposes of limitation. For example, each element explained as one unit may be implemented in separate units and likewise, elements explained as separate units may be implemented in a combined form.

Therefore, the scope of the inventive concepts are defined not by the detailed description but by the appended claims, and the meaning and scope of claims and all modifications or modified forms derived from concepts equivalent to claims will be construed as being included in the inventive concepts.

What is claimed is:

1. A method of a remote controller for controlling a display device, the method comprising:
capturing an image of an object;
detecting information about at least one of a shape, location, distance, and movement of the object based on the captured image; and
transmitting the detected information to the display device.

2. The method of claim 1, wherein the capturing an image of the object comprises capturing an image of the object from a motion sensor included in the remote controller.

3. The method of claim 2, further comprising:
detecting at least one of an angle and a direction of the remote controller;
comparing at least one of the detected angle and direction with a reference range; and
selectively activating the motion sensor included in the remote controller based on the comparison.

4. The method of claim 3, wherein the activating the motion sensor comprises activating one of the motion sensor and a touch sensor, which are included in the remote controller, based on the comparison.

5. The method of claim 1, wherein the detecting information about at least one of the shape, location, distance, and movement of the object comprises:
detecting a boundary of the object included in the captured image that matches a template stored in advance; and
detecting information about at least one of the shape, location, distance, and movement of the object based on the detected boundary.

6. The method of claim 5, wherein the template stored in advance comprises a template of a shape of a finger.

7. The method of claim 1, further comprising:
receiving a user input of a user touching a partial area of a ridge bar provided in the remote controller; and
transmitting location information about the touched partial area to the display device.

8. A remote controller comprising:
a communicator configured to transmit and receive data to and from a display device;
an image obtainer configured to capture an image of an object; and
a controller configured to, based on the captured image, detect information about at least one of the shape, location, distance, and movement of the object, and transmit the detected information to the display device through the communicator.

9. The remote controller of claim 8, wherein the image obtainer comprises a motion sensor.

10. The remote controller of claim 9, wherein the controller is further configured to:
detect at least one of an angle and a direction of the remote controller;
compare at least one of the detected angle and the direction with a reference range; and
selectively activate the motion sensor provided in the remote controller based on the comparison.

11. The remote controller of claim 10, wherein
the controller is further configured to activate one of the motion sensor and a touch sensor, which are included in the remote controller, based on the comparison.

12. The remote controller of claim 8, wherein the controller is further configured to detect a boundary of the object included in the captured image that matches a template stored in advance, and detect information about at least one of the shape, location, distance, and movement of the object based on the detected boundary.

13. The remote controller of claim 12, wherein the template stored in advance comprises a template of a shape of a finger.

14. The remote controller of claim 8, further comprising:
a ridge bar; and
a user interface configured to receive a user input of a user touching a partial area of the ridge bar, and
wherein the controller is further configured to transmit, to the display device, information about a location of the partial area that the user touched.

15. A computer-readable recording medium having embodied thereon a computer program for executing the method of claim 1.

16. A control apparatus comprising:
a communicator configured to transmit and receive data to and from a display apparatus;
a ridge bar configured to receive a user input; and
a controller configured to determine a location of the user input, and control the display apparatus according to the location of the user input.

17. The control apparatus of claim 16, wherein the controller is further configured to:
determine a ratio corresponding to a comparison between the location of the user input and an entire length of the ridge bar; and
according to the determined ratio, determine a replay time point for a video that is being displayed on the display apparatus.

18. The control apparatus of claim 17, wherein the display apparatus further comprises a user interface.

19. The control apparatus of claim 18, wherein the user interface is configured to display a plurality of thumbnail images corresponding to a plurality of time points in the video.

20. The control apparatus of claim 19, wherein the user interface is further configured to display the thumbnail image, from among the plurality of thumbnail images, that corresponds to the replay time point, with a distinguishing feature.
